(19) United States
(12) Patent Application Publication
(10) Pub. No.: US 2016/0279665 A1
(43) Pub. Date: Sep. 29, 2016

(54) Puncturing Device For Viscous Food Container

(71) Applicant: Prince Castle LLC, Carol Stream, IL (US)

(72) Inventor: Loren Veltrop, Chicago, IL (US)

(73) Assignee: Prince Castle LLC, Carol Stream, IL (US)

(21) Appl. No.: 14/671,406

(22) Filed: Mar. 27, 2015

(51) Int. Cl. B05C 17/005; B26F 1/32; B05C 17/01

(52) U.S. Cl. CPC B05C 17/00586; B05C 17/00583; B05C 17/01; B26F 1/32

(57) ABSTRACT

A puncturing device and a system for dispensing viscous food include a puncturing device for cutting self-sealing orifices in flexible containers containing viscous food. The puncturing device includes a housing. A plunger is translatable within the housing between a retracted position and an extended position. At least one blade is secured to the plunger. The at least one blade is configured to cut a self-sealing orifice in a flexible container containing viscous food.

### BACKGROUND

The present disclosure is related to the field of dispensing viscous food products. More particularly, the present disclosure is related to a puncturing device for containers of viscous food product.

A viscous food product, as used herein includes food products such as, but not limited to pancake batter, syrups, and various types of condiments that include mayonnaise, guacamole, ketchup, and mustard. Such foods are often provided to restaurant and food service providers in rigid paper or plastic tubes. The viscous food products are dispensed or served using sauce dispensing guns. Many viscous food products are pasteurized or treated for consumption using high-pressure pasteurization. Prior art tubes and other rigid or semi-rigid container have been used. However, development in packaging and particularly high-pressure pasteurization techniques used in treatment of viscous food products make these rigid or semi-rigid containers ill suited for use. Rather, flexible containers such as bags or pouches containing the viscous food product are desired. One example of such a solution is disclosed in U.S. patent application Ser. No. 13/413,608 filed on Mar. 6, 2012 entitled Dispenser for Viscous Food Products, which is incorporated herein by reference in its entirety.

However, flexible containers for viscous food products present their own challenges, including repeatedly dispensing consistent portion size. Some embodiments of flexible containers use a “self-sealing” orifice exemplarily constructed with cuts through the flexible container, creating one or more panels out of the material of the flexible container, which due to the physical and mechanical properties of the material itself, viscous food product in the container, and the shape of the one or more panels, dispense viscous food product therethrough when pressure is applied to the flexible container.

Solutions are desired to create such self-sealing orifices in flexible containers of viscous food products in manners that promote the repeated dispensing of consistent portion size therethrough.

### BRIEF DISCLOSURE

A puncturing device for cutting self-sealing orifices in flexible containers containing viscous food include a housing. A plunger is translatable within the housing between a retracted position and an extended position. At least one blade is secured to the plunger. The blade is configured to cut a self-sealing orifice in a flexible container containing viscous food.

An exemplary embodiment of a system for dispensing viscous food includes a viscous food dispenser. The viscous food dispenser includes a dispensing gun, at least one piston actionable by a trigger of the dispensing gun and a cylinder. The cylinder includes an at least partially open end. At least a portion of the at least one piston is received within an open interior of the cylinder. A flexible container contains viscous food product. The flexible container is located within the cylinder between the at least one piston and the at least partially open end. A portion of the flexible container is exposed through the at least partially open end. A puncturing device includes a housing. A plunger is translatable within the housing between a retracted position and an extended position. At least one blade is secure to the plunger. The housing is configured to engage the viscous food dispenser to align the at least one blade with the portion of the flexible container exposed through the at least one open end. The at least one blade is configured to cut a self-sealing orifice in the flexible container when the plunger is translated to the extended position.

An exemplary embodiment of a puncturing device for cutting self-sealing orifices in flexible containers containing viscous food includes a housing. The housing includes a handle tube and a dispenser tube and a shoulder extending between the handle tube and the dispenser tube. At least one blade is configured to cut a self-sealing orifice in a flexible container containing viscous food. A plunger is secured to the at least one blade and is translatable within the handle tube between a retracted position wherein the at least one blade is retracted into the handle tube and an extended position wherein the at least one blade extends into the dispenser tube. A spring extends between the handle tube and the plunger. The spring is configured to place a biasing force against the plunger to bias the plunger in the retracted position.

### BRIEF DESCRIPTION OF THE DRAWINGS

FIG. 1 is a perspective view of an exemplary embodiment of a puncturing device.

FIG. 2 is a front sectional view of an exemplary embodiment of a puncturing device.

FIG. 3 is an end view of an exemplary embodiment of a viscous food product dispensing gun.

FIG. 4 is an isolated top view of the end of the viscous food product dispensing gun depicted in FIG. 3.

FIG. 5 is a perspective sectional view of an exemplary embodiment of the housing.

FIG. 6 is a bottom view of the exemplary embodiment of the housing.

FIG. 7 is a front view of an exemplary embodiment of a plunger.

FIG. 8 is a cross-sectional view of the exemplary embodiment of a plunger.

FIG. 9 is a cross-sectional view taken along line 9-9 of FIG. 2.

FIG. 10 is a cross-sectional view taken along line 10-10 of FIG. 2.

FIG. 11 is a cross-sectional view taken along line 11-11 of FIG. 2.

FIG. 12A is an exemplary partial sectional view of a viscous food product dispenser in operative connection with an embodiment of a puncturing device in the retracted position.

FIG. 12B is an exemplary partial sectional view of a viscous food product dispenser in operative connection with an embodiment of the puncturing device in the extended position.

### DETAILED DISCLOSURE

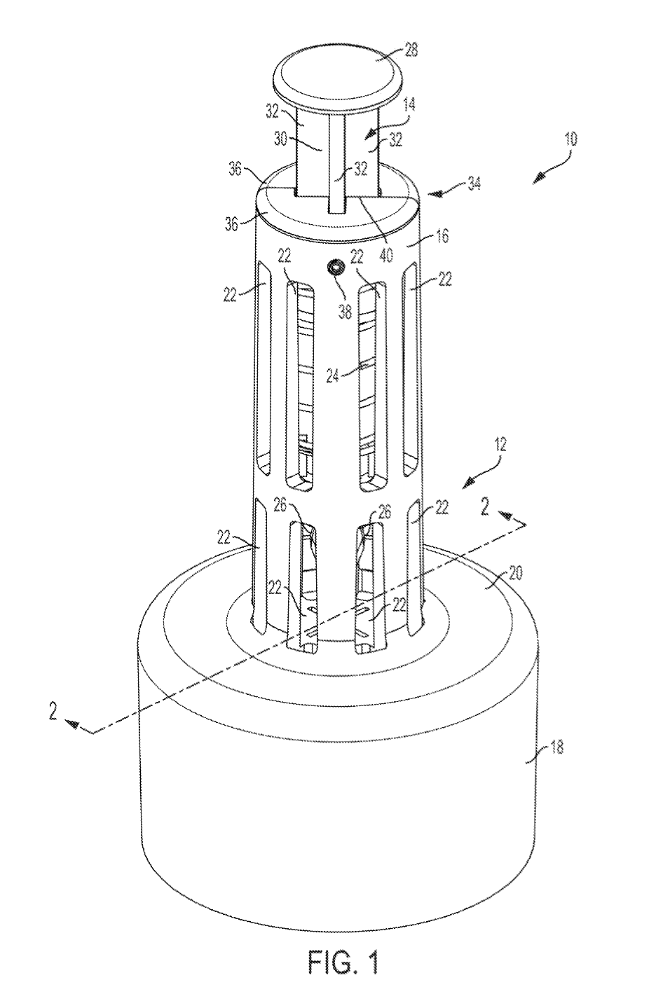

FIG. 1 depicts an exemplary embodiment of a puncturing device 10 particularly configured and suited to create a self-sealing orifice in a flexible container of viscous food product. Embodiments of the puncturing device 10 include a housing 12 and a plunger 14.

The housing 12 may include a handle tube 16 connected to a dispenser tube 18 by a shoulder 20. The housing 12 further includes a plurality of openings 22, which may be arranged in an elongated fashion along the handle tube 16. In an exemplary embodiment as depicted in FIG. 1, the openings 22 may be arranged into upper openings generally in alignment with a spring 24 disposed within the handle tube 16 as will be described in further detail and a series of lower openings generally arranged relative to at least one blade 26 of the plunger 14 as will be described in further detail herein. In a still further exemplary embodiment, the openings 22 may extend through the shoulder 20 into an interior of the dispenser tube 18.

The plunger 14, as will be described in further detail herein, generally includes a handle 28 connected to a shaft 30 that is arranged to slidably move with in at least the handle tube 16. In an exemplary embodiment, the shaft 30 includes a plurality of ribs 32 which is exemplarily depicted in FIG. 1 as including four ribs 32. As previously mentioned, the plunger 14 terminates in at least one blade 26 which will be described in further detail herein and which extends downwardly away from the shaft 30.

A retainer cap 34 is secured at the top of the handle tube 16 in a manner to surround the plunger 14, and in an embodiment, the shaft 30 of the plunger 14. In the embodiment depicted, the retainer cap 34 is constructed of two or more cap portions 36. The cap portions 36, or retainer cap 34 are secured to the housing 12, exemplarily by at least one set screw 38 that extends through the housing 12 and at least into a portion of the retainer cap 34. It will be recognized that in alternative embodiments, other connection solutions, including, but not limited to screw fit, snap fit, and friction fit may be used to secure the retainer cap 34 to the housing 12 while in other embodiments, the retainer cap 34 may be formed as an integral portion of the housing 12 or may be secured for example by adhesive or ultrasonic welding. Embodiments of the retainer cap 34 further include a plunger cut out 40 through the retainer cap 34. In embodiments, the plunger cut out 40 is dimensioned to match a shape of the shaft 30 of the plunger 14. In the embodiment depicted, the shaft 30 is in a cross-sectional shape of a cross and therefore, the depicted plunger cut out 40 is also exemplarily in a cross shape. This difference between the shaft 30 of the plunger 14 and the plunger cut out 40, alignment of the plunger 14 as it travels within the housing 12 as will be described in further detail herein.

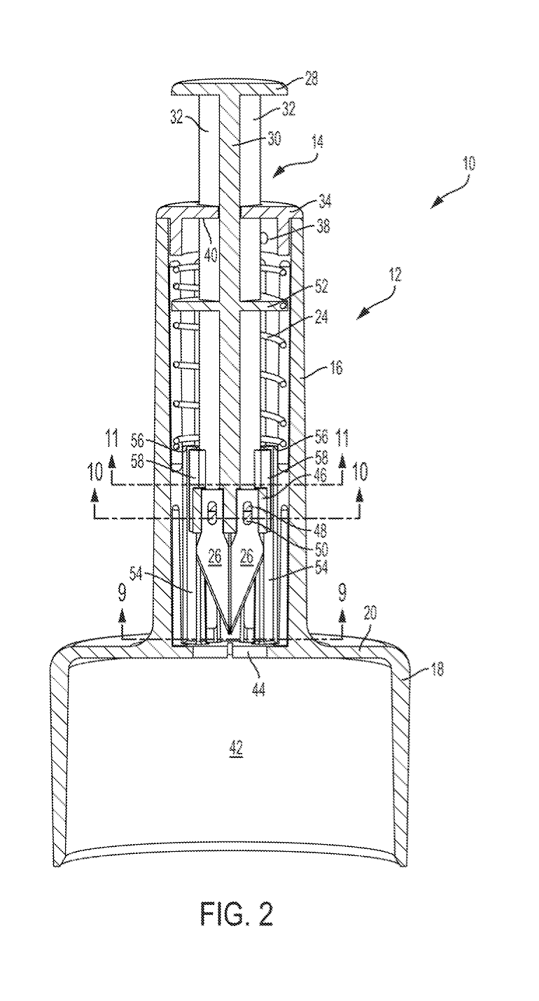

FIG. 2 is a cross sectional view of the puncturing device 10 exemplarily taken along line 2-2 in FIG. 1. In addition to many of the structures as described above with respect to FIG. 1, the cross-sectional view provided FIG. 2 further depicts features of an embodiment of the puncturing device 10, including the open interior 42 of the dispenser tube 18. A blade hole 44 extends through the shoulder 20 between the handle tube 16 and the dispenser tube 18 to create a path for the at least one blade 26 to extend through the shoulder 20 into the open interior 42 of the dispenser tube 18.

The at least one blade 26 is secured to the shaft 30 of the plunger 14 by a blade head 46. In exemplary embodiments, the at least one blade 26 may be injection molded or cast into the blade head 46 while in alternative embodiments, the blade head 46 may be constructed in two or more pieces and the at least one blade 26 secured within the blade head 46 as the pieces of the blade head 46 are assembled. In the embodiment depicted in FIG. 2, the blades 26 include a retention hole 48 through which a retention feature 50 of the blade head 46 extends to retain the blades 26 within the blade head 46. Still further manners in which the blades 26 may be secured to the blade head 46 will be recognized by a person of ordinary skill in the art in view of this disclosure.

The shaft 30 of the plunger 14 further includes a spring ledge 52 to which the spring 24 is secured. The spring 24 may exemplarily abut the spring ledge 52, or may be connected to the spring ledge, exemplarily by extending through a portion of the spring ledge 52. In embodiments, the spring 24 creates a biasing force between the plunger 14 and the housing 12 to bias the plunger 12 in a retracted position wherein the at least one blade 26 is retracted into the open interior of the handle tube 16. In an exemplary embodiment, the spring 24 engages the plunger 14 at the spring ledge 52 and engages the housing 12 at housing fingers 54, particularly at a top 56 of the housing fingers 54. The ribs 32 of the shaft 30 of the plunger 14 may further include alignment projections 58 which will be described in further detail herein which may also be formed as part of the blade head 46. The alignment projections 58 form respective alignment recesses which slidingly engage the housing fingers 54 to further ensure that the plunger 14 translates coaxially to the handle tube 16 to keep the at least one blade 26 in alignment with the blade hole 44 through the shoulder 20, and also to limit any additional error or movement by the at least one blade 26 either during translation or engagement with a flexible container of viscous food product when cutting a self-sealing orifice therein, as will be described in further detail herein.

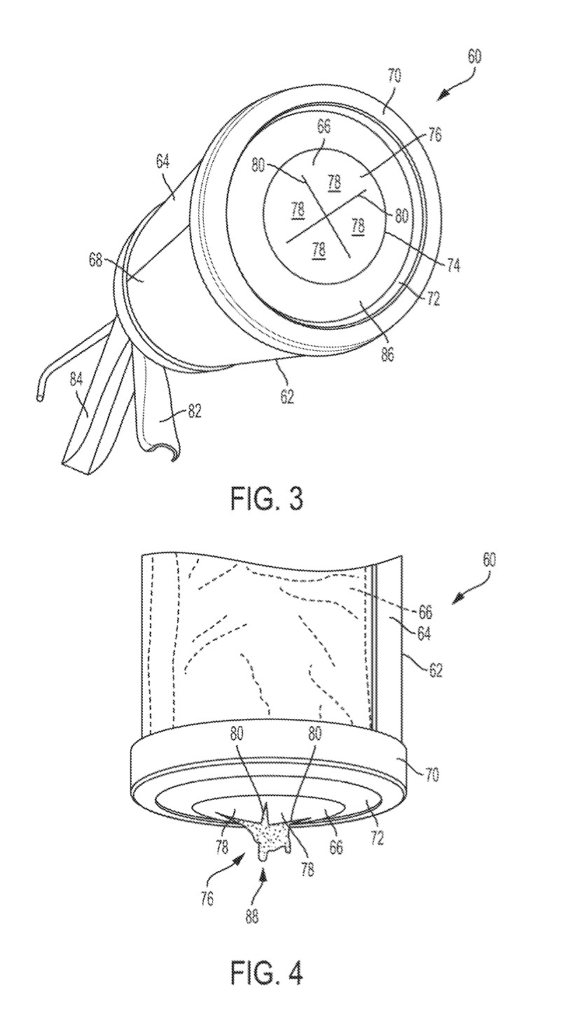

FIG. 3 is an end view of an exemplary embodiment of a viscous food dispenser 60. It includes a dispensing gun 62, a hollow cylinder 64 and a flexible, viscous food product-containing container 66. The cylinder 64 is sized, shaped, and arranged to fit within the dispensing gun 62, exemplarily in a cradle 68 which is exemplarily constructed as a half-cylinder which generally forms the body of the dispensing device 60. The cylinder 64 further engages a front end 70 of the dispensing gun 62. The front end 70 is exemplarily constructed as an annulus that engages both a portion of the front and the side of the cylinder 64, exemplarily to retain the cylinder 64 is sized, shaped, and arranged to fit within the dispensing gun 62 or exemplarily in the manner as described above. The cylinder 64 is also configured to receive the flexible container 66 filled with viscous food product inside the cylinder.

The cylinder is exemplarily constructed of a flexible, semi-flexible or resilient material. The cylinder 64 includes an end 72, which is partially “closed” by a flange 86 of which the end 72 is comprised, thus forming an opening 74 through the cylinder 64 exposing a portion of the flexible container 66 filled with viscous food product. The flange 86 is exemplarily a ring or ring-like in shape forming the opening 74 that is exemplarily circular and exemplarily of a size sufficiently large such that an entirety of a self-sealing orifice 76 formed in the flexible container by the puncturing device 10 as described herein is fully exposed by the opening 74. In use, the opening 74 is sufficiently large such that the self-sealing orifice 76 can be formed in the flexible container 66 with the puncturing device while the flexible container 66 is held within the cylinder 64. The opening 74 is large enough to encircle each of a plurality of panels 78 forming the self-sealing orifice 76. In an exemplary embodiment, the at least one panel 78 of the self-sealing orifice is formed by at least one cut 80 through the flexible container 66 by the puncturing device 10. While the embodiment depicted in FIG. 3 exemplarily shows two cross cuts 80 forming four panels 78, it will be recognized that various other embodiments may be more or fewer cuts resulting in more or fewer panels. The opening 74 is large enough to encircle the panels 78 of the self-sealing orifice 76 which opens and closes responsive to force applied to and removed from the panels by the dispensing gun 60. The opening 74 also allows a corresponding portion of the flexible container to extend outwardly from the opening 74 by a small distance and be kept taught or slightly stretched, such as is exemplarily depicted in FIG. 4.

The self-sealing orifice 76 is exemplarily embodied with four, flexible plastic triangular-shaped panels 78 defined by two substantially orthogonal cuts 80 through the material of the flexible container 66. The cuts 80 are exemplarily of equal length and are further exemplarily orthogonal to one another. However, it will be recognized that any of a variety of cut orientations for arrangements may be used in exemplary embodiments and as may be recognized by a person of ordinary skill in the art to achieve the dispensing properties desired of the self-sealing orifice 76. Non-limiting examples of self-sealing orifice configurations may include asymmetric arrangements of cuts, more or fewer than four cuts, multiple cuts (e.g. two, three, or more) forming a single panel, and panels of asymmetric sizes or shapes. It will be recognized that the puncturing device will be configured, including, but limited to the number and arrangement of blades and the blade head in order to achieve the order, shape, and orientation of panels in the self-sealing orifice.

When a viscous food product inside the cylinder (and exemplarily within the flexible container 66 within the cylinder 64) is urged against the panel 78, the force of the viscous food product against the panels 78 causes the panels 78 to react or bend outwardly. In the embodiment depicted, the panels are all substantially equal and thus have substantially equal bias and mechanical properties such that the force of the viscous food product is evenly applied to each of the panels 78. This may exemplarily occur when the self-sealing orifice is centered within opening 74. Since the panels 78 consist of the same flexible yet resilient material from which the flexible container 66 is constructed, the panels 78, when substantially equal in shape and area, will react or bend outwardly in substantially the same way. When a force applied to the panels 78 from the viscous food product is removed, the panels 78 will return to their original shape in substantially the same way at substantially the same time.

It will be recognized that in alternative embodiments, the puncturing device may be configured to create either one panel with multiple cuts or asymmetric panels and/or cuts depending upon the mechanical properties of the self-sealing orifice desired for the dispense of the viscous food product. Additional embodiments may locate the self-sealing orifice in a particular location or orientation within the opening 74 relative to the flange 86. Location of the self-sealing orifice 76 in this manner may further affect the mechanical properties of the dispense of the viscous food product.

The self-sealing orifice 76 formed by the at least one panel 78 is considered to be “self-sealing” because the stiffness of the material from which the flexible container 66 and the at least one panel 78 is constructed causes the at least one panel 78 to return to its original shape and position and because the at least one cut 80 that defines the at least one panel 78 is configured for the particular food product in the flexible container 66 to flow therethrough. The at least one panel 78 thus opens responsive to an applied force supplied by a viscous food product but then is configured to close when this deflection force is removed or relieved. The efficacy of the self-sealing orifice 76, e.g. the tightness of the orifice 76, will thus depend in part upon the resilience or stiffness of the material from which the flexible container wall is formed, the thickness of the material from which the flexible container is formed, the length, width, and orientation of any cuts 80 as well as the shape, surface area, and orientation of the at least one panel, and the viscosity of the material to be dispensed.

While not depicted, the dispensing gun 60 includes at least one piston, exemplarily actuated by a trigger 82. In the embodiment depicted in FIG. 3, the trigger 82 is gripped and squeezed by a user in a direction of a non-moving handle 84 which urges an internal piston (not depicted) against the flexible container 66 within the cylinder 64. In some embodiments, a second piston is located within the cylinder itself, which is engaged by the piston of the dispensing gun 62, alternative embodiments only use one of these two pistons. Other exemplary embodiment of the trigger and operation fo the dispensing gun will be recognized by a person of ordinary skill in the art. When the flexible container 66 is placed into the cylinder 64, the opening 74 in the end 72 of the cylinder 64 “exposes” a portion of the flexible container 66 wherein the self-sealing orifice 76 may be located as described in further detail herein. FIG. 3 further depicts one exemplary desirable embodiment in that the self-sealing orifice 76 is centered within the opening 74, further facilitating even or known forces applied to the panels of the self-sealing orifice 76 when the dispensing gun 60 is operated. When the forces applied to the panels 78 of the self-sealing orifice 76 are known or repeatable, viscous food product in the bag, exemplarily urged by the piston previously described forces food product out of the self-sealing orifice 76 in a known or repeatable amount.

The opening 74 is defined by a flange 86 forming the front end 72 of the cylinder 64. The flange 86 is exemplarily depicted as a ring or annulus shape which may exemplarily form a circular opening 74, although it is recognized that other shapes or configurations of the flange 86 may be used in alternative embodiments. The flange 86 holds the flexible container 66 in the cylinder 64, especially when the piston (not depicted) of the dispensing gun 60 pushes the flexible container and the viscous food product contained therein toward the second end 72 of the cylinder 64. The flange 86 serves the functions of retaining the flexible container 66 within the cylinder 64 and directs the force applied to the viscous food product within the flexible container 66 against the self-sealing orifice 76.

FIG. 4 is an isolated top view of the front end of the dispensing gun 60. The flexible container 66 is primarily shown in phantom lines (as a substantial portion of the flexible container 66 is located within the cylinder 64. A front portion of the flexible container 66, primarily the self-sealing orifice 76 extends outwardly a small distance from the opening 74 of the cylinder 64. This is at least in part due to the force applied to the flexible container by the at leas ton piston. Viscous material 88 is depicted as being dispensed from the self-sealing orifice 76 formed in the flexible container 66.

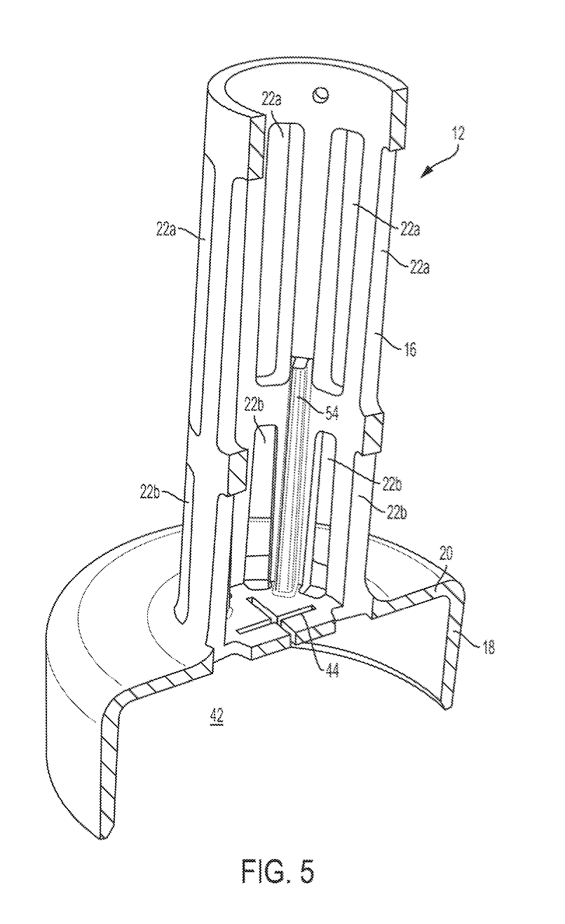

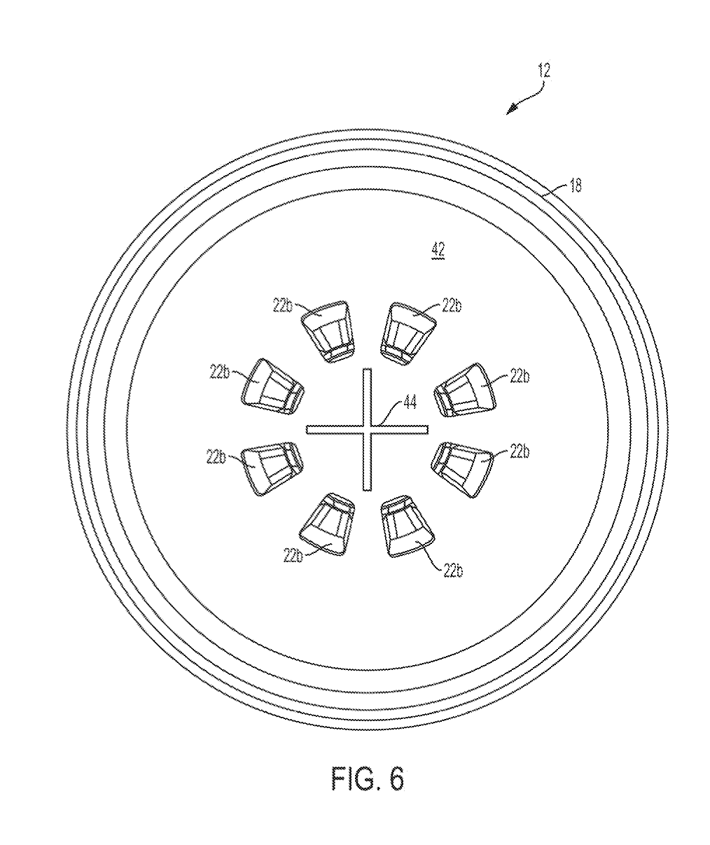

FIG. 5 is a cut away view of the housing 12 which highlights features as previously described above, particularly the blade hole 44 that extends through the shoulder 20 into the open interior 44 of the dispenser tube 18. Additionally, the opening 22, which exemplarily includes upper openings 22a and lower openings 22b, but may alternatively include any other number of openings along the length of the handle tube 16. As can be seen in FIG. 5, the lower openings 22b extend through the shoulder 20 into the open interior 42 of the dispenser tube 18 as well. The plurality of openings in the handle tube 16 and into the dispenser tube 18 facilitates cleaning of the puncturing device 10, exemplarily by promoting water flow through the device such as the clean viscous food from the blade or other components of the puncturing device. Exemplarily, the upper openings 22a are generally in alignment with the spring 24. This facilitates cleaning of the spring 24 and an upper portion of the plunger 14. The lower openings 22b are generally in alignment with the blades 26 when the blades 26 are in the retracted (biased) position. This facilitates cleaning of the blades 26. The extension of the lower openings 22b through the shoulder further facilitates cleaning of the blades 26 and the interior of the dispenser tube 18 by creating a flow path through the shoulder 20.

FIG. 5 further depicts the housing finger 54 which, in embodiments, is engaged by both the alignment projections 58 of the plunger (not depicted) as well as by the spring (not depicted) of the plunger. In embodiments, the housing 12 includes a plurality of housing fingers 54, which in one embodiment is four evenly spaced housing fingers 54, although more or fewer housing fingers 54 may be used in other embodiments.

FIG. 6 is a bottom view of the housing 12, primarily depicting the dispenser tube 18 and the open interior 42 within the dispenser tube 18. FIG. 6 further depicts the blade hole 44 and the lower openings 22b which extend through the shoulder into the open interior 42. As described in further detail herein, in embodiments, the open interior 42 is dimensioned to fit a front end of the dispenser to align the blades 26 with the flexible container 66 to properly position the self-sealing orifice 76. While the dispenser tube 18 and the open interior 42 are depicted as being circular in cross section, it will be recognized that the dispenser tube 18 and/or the open interior 42 may be dimensioned, configured, or arranged to securely engage a front end of a dispenser. In an embodiment wherein the self-sealing orifice is to have a specific angular orientation or is located at a position not along a geometric axis of the puncturing device. Dispense, and/or cylinder, the dispenser rube 18 and/or the open interior 42 may include a registration feature (not depicted) to promote or ensure a desired angular orientation between the puncturing device 10 and the dispenser or cylinder.

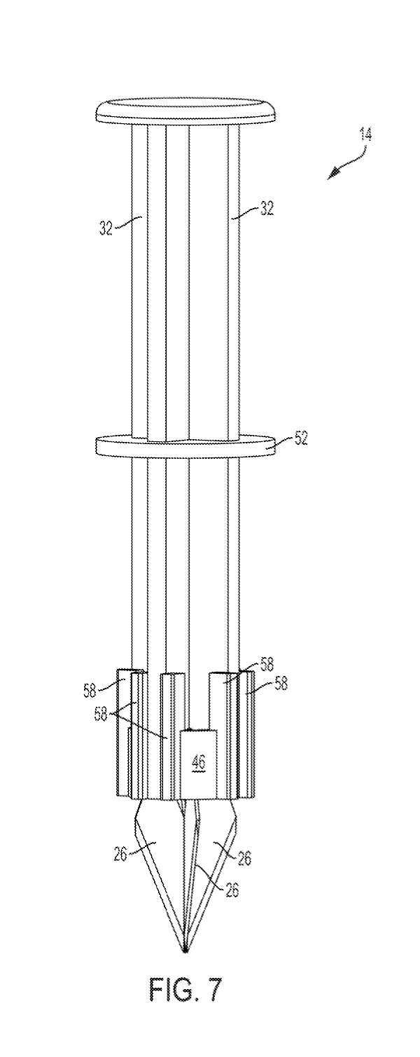

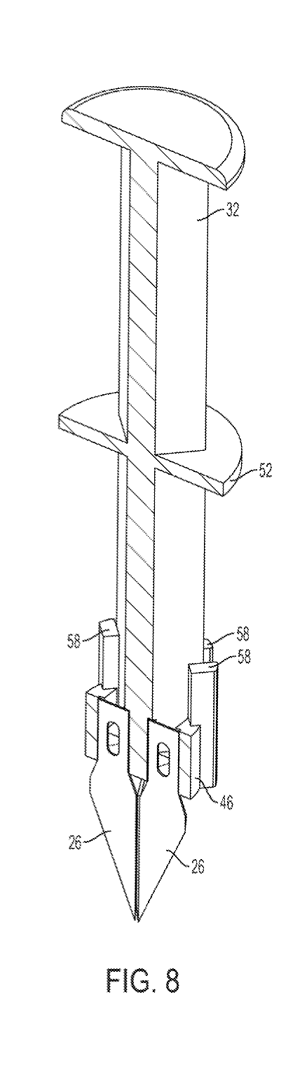

FIG. 7 is a perspective view of the plunger 14. FIG. 8 is a sectional view of the plunger 14. FIGS. 7 and 8 exemplarily depict the features of the plunger 14 described above in further detail. The plunger 14 includes a plurality of ribs 32 extending along a length of the plunger 14. The plunger includes a spring ledge 52 to which the spring (not depicted) is secured in order to bias the plunger 14 exemplarily in the retracted position within the housing 12. Two alignment projections 58 extend from each of the ribs 32. Each pair of alignment projections 58 engages a housing finger (not depicted) extending interiorly from the handle tube 16. This sliding engagement facilitates alignment of the blades 26 with the blade hole (not depicted) of the housing. The at least one blade 26 is secured within the blade head 46, exemplarily by injection molding, but other manners of manufacture may also be used.

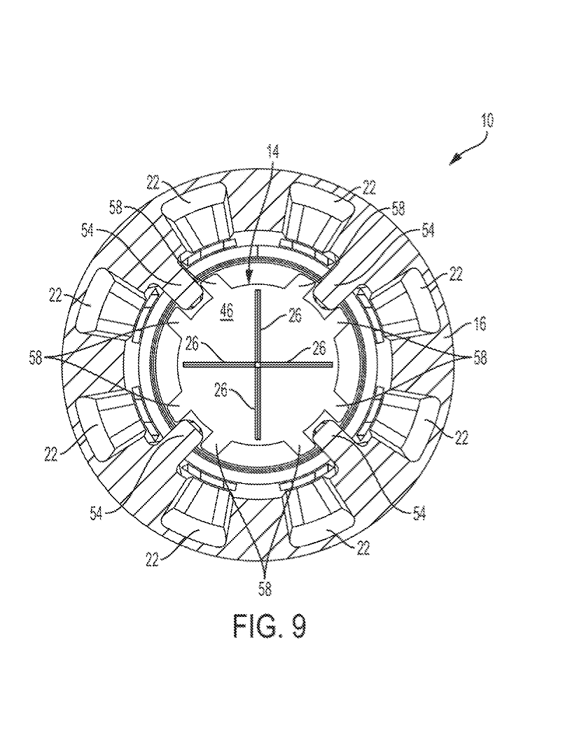

FIGS. 9, 10, and 11 are all cross sectional views of an embodiment of the puncturing device 10, and respectively taken along lines 9-9, 10-10, and 11-11 depicted in FIG. 2. These cross sectional views further highlight various features as described above.

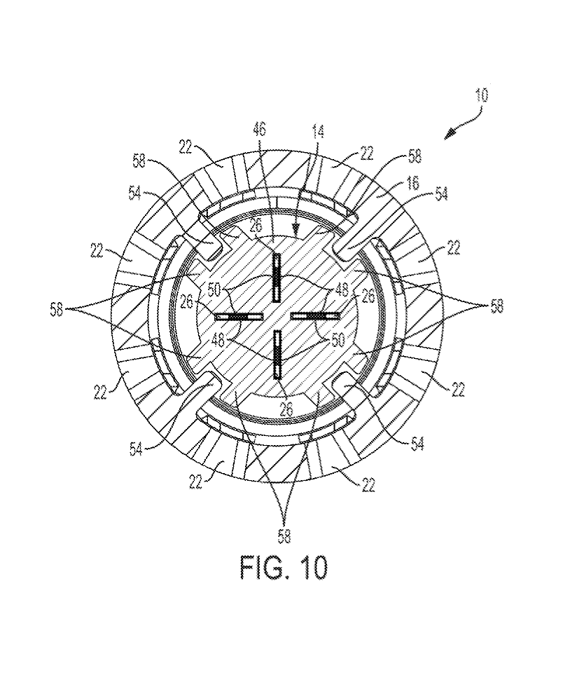

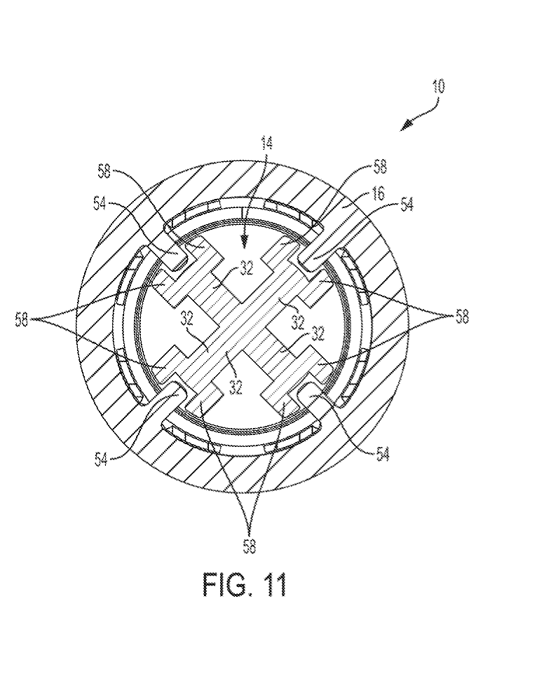

FIG. 9 depicts the blades 26 extending from the bottom of the plunger 14 while the alignment projections 58 engage respective housing fingers 54 to maintain alignment of the blades 26 within the puncturing device 10. FIG. 10 is a cross sectional view through the blade head 46, and thus the retention holes 48 through the blades 26 and the corresponding retention features 50 can be seen to secure the blades 26 within the blade head 46. The alignment projections 58 and corresponding housing fingers 34 are also visible in this view as well. The view of FIG. 11 is a cross sectional view taken above the blade head (not depicted) and thus, the ribs 32 of the plunger 14 are visible, along with the alignment projection 58 extending from the ends of each of the ribs 32 for engagement with the housing finger 54.

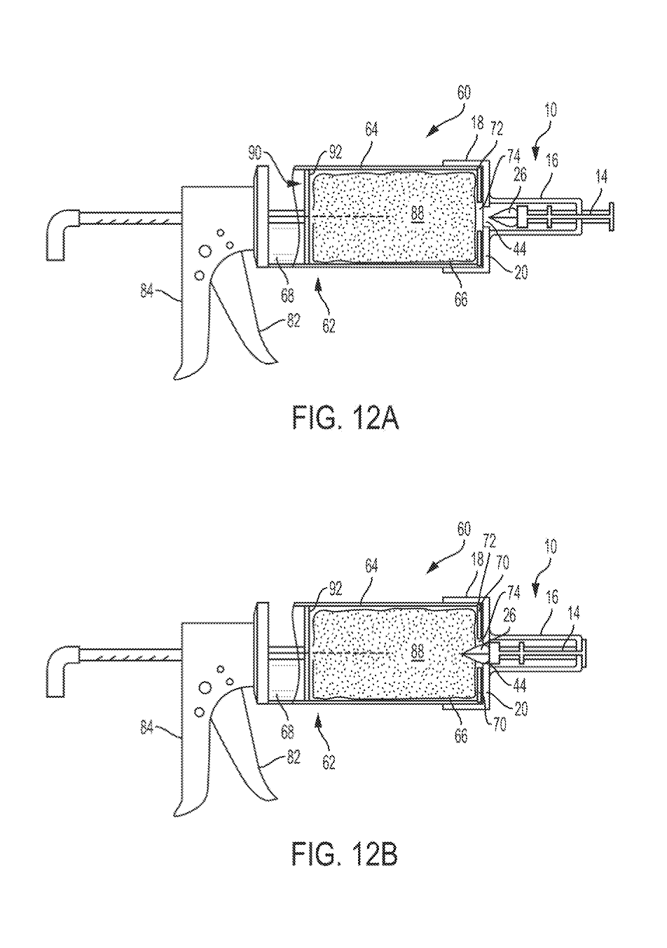

FIGS. 12A and 128 are partial cross sectional views depicting an exemplary embodiment of use of a puncturing device 10 with a dispenser 60. The flexible container 66 further includes viscous food product 88 and is positioned within a cylinder 64, exemplarily through an open back end 90 of the cylinder 64. The dispensing gun 62 is operated, exemplarily by squeezing a trigger 82 against a handle 84 to advance at least one piston 92 to position the flexible container 66 to the front end 72 of the cylinder 64.

The front end 72 of the cylinder 64 is retained by the front end 70 of the gun 62 in a forward most position for the cylinder 64. When aligned this way, a portion of the flexible container 66 is exposed out of the front end 70 of the gun 62 and the opening 74 located in the end 72 of the cylinder 64.

The puncturing device 10 is further secured to the end of the dispenser 60. While in the embodiment exemplarily depicted, the puncturing device 10 is located with the dispenser tube 18 surrounding both the cylinder 64 and the front end 70 of the dispensing gun 62, it will be recognized that in an alternative embodiment, the dispenser tube 18 may receive only the cylinder 64 containing the flexible container 66 of viscous food product. The dispenser tube 18 of the puncturing device 10 is dimensioned such at to securely fit over the front end 70 of the dispensing gun 62. The puncturing device 10 is further oriented such that the handle tube 16 and plunger 14 containing the blades 26 are also aligned with a desired position of the self-sealing orifice 76 in the flexible container 66. In an exemplary embodiment, the handle tube 16, plunger 14, and at least one blade 26 is aligned axially with the center of the opening 74 in the cylinder 64 which exposes a portion of the flexible container 66. In an exemplary embodiment, therefore the blade hole 44 is coaxially aligned with the opening 74. However, it will be recognized that in alternative embodiments, another position of the at least one blade 26 may be desired relative to the opening 74 and the puncturing device 10, including, but not limited to the handle tube 16, dispenser tube 18, plunger 14, and the at least one blade 26 may be configured accordingly. In a still further exemplary embodiment, the blade hole 44 is similarly aligned with the desired position of the self-sealing orifice 76 to be made in the flexible container 66. In exemplary embodiments, the puncturing device 10 may include a registration feature to ensure proper alignment of the blades 26 with the desired location of the self-sealing orifice.

FIG. 12A depicts the dispenser 60 and the puncturing device 10 when the puncturing device 10 is in the retracted position. This is exemplarily achieved by a spring located within the handle tube 16 and configured to bias the plunger 14 in the retracted position, although the spring is not depicted for simplicity of the Figure.

Exemplarily by overcoming this biasing force with a greater translation force placed on the plunger 14, the plunger 14 translates within the handle tube 16 to an extended position exemplarily depicted in FIG. 12B. The plunger 14 is exemplarily guided by the engagement of the housing fingers 54 and alignment projections 58 as described above to move the at least one blade 26 through the blade hole 44 and the opening 74 to pierce the flexible container 66 with the one more blades 26 in order to make the cuts in the flexible container which form the at least one panel of the self-sealing orifice as described above. Upon release of the translation force applied to the plunger 14, the biasing force on the plunger 14 again moves the plunger 14 back to the retracted position depicted in FIG. 12A.

Exemplary embodiments of the functional device as described herein facilitate a user to consistently and repeatedly form a self-sealing orifice in flexible containers of viscous food product. As the position, dimensions, and arrangement of the cuts of the self-sealing orifice as well as the mechanical properties of the flexible container itself contribute to the repeated dispense of consistent portions of viscous food product therefrom upon actuation of the dispenser, such repeatable creation of the self-sealing orifice is desired. Embodiments of the puncturing device disclosed herein enable a user to quickly and repeatedly properly align the puncturing device with the flexible container, whether the flexible container is located within a cylinder and/or a dispensing gun. Such features make the puncturing device as disclosed herein easy to use by users and the puncturing device is biased to be held in the retracted position such that the at least one blade is surrounded by the housing which promotes safety of the user. The orientation and configuration of various openings through the housing further facilitate cleaning of not only the at least one blade, but the spring and plunger, as well as any other portion of the puncturing device that may come in contact with the viscous food product.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A puncturing device for cutting self-sealing orifices in flexible containers containing viscous food, the puncturing device comprising:
a housing;
a plunger translatable within the housing between a retracted position and an extended position;
at least one blade secured to the plunger, the at least one blade configured to cut a self-sealing orifice in a flexible container containing viscous food.

2. The puncturing device of claim 1, further wherein the housing comprises a handle tube and a dispenser tube.

3. The puncturing device of claim 2, wherein the plunger is translatable within the handle tube to extend the at least one blade into the dispenser tube when the plunger is in the extended position and retract the blade into the handle tube when the plunger is in the retracted position.

4. The puncturing device of claim 2, wherein the plunger is translatable within the handle tube and the dispenser tube is configured to engage about a dispenser comprising the flexible container containing viscous food.

5. The puncturing device of claim 4, wherein the dispenser tube is configured to align the at least one blade with a predetermined location on the flexible container containing viscous food for a self-sealing orifice therein.

6. The puncturing device of claim 5 wherein the at least one blade is a plurality of blades configured to cut the self-sealing orifice in the flexible container, the self-sealing orifice comprising a predetermined configuration and alignment of cuts.

7. The puncturing device of claim 2, wherein the handle tube further comprises a plurality of elongated openings therethrough.

8. The puncturing device of claim 7, wherein at least a portion of the plurality of elongated openings open into the dispenser tube.

9. The puncturing device of claim 2, wherein the housing further comprises a shoulder between the handle tube and the dispenser tube, the shoulder further comprising a blade hole extending through the shoulder between the handle tube and the dispenser tube and aligned with the at least one blade, wherein the blade hole is configured to permit translation of the at least one blade into and out of the dispensing tube.

10. The puncturing device of claim 1, wherein the at least one blade is four blades in the shape of a symmetrical cross.

11. The puncturing device of claim 1, further comprising a spring extending between the plunger and the handle tube, the spring configured to bias the plunger in the retracted position.

12. The puncturing device of claim 1, wherein the plunger comprises a plurality of alignment projections and the handle tube comprises a plurality of inwardly extending housing fingers, and at least one alignment projection engages each of the housing fingers to align translation of the plunger within the handle tube

13. The puncturing device of claim 12, wherein the plunger comprises a plurality of ribs and each rib comprises two alignment projections.

14. A system for dispensing viscous food, the system comprising:
a viscous food dispenser comprising a dispensing gun, at least one piston actionable by a trigger of the dispensing gun, and a cylinder comprising an at least partially open end, at least a portion of the at least one piston received within an open interior of the cylinder;
a flexible container containing viscous food product, located within the cylinder between the at least one piston and the at least partially open end wherein a portion of the flexible container is exposed through the at least partially open end; and
a puncturing device comprising a housing, a plunger translatable within the housing between a retracted position and an extended position, and at least one blade secured to the plunger, wherein the housing is configured to engage the viscous food dispenser to align the at least one blade with the portion of the flexible container exposed through the at least one open end, and the blade is configured to cut a self-sealing orifice in the flexible container when the plunger is translated to the extended position.

15. The system of claim 14, wherein the housing comprises a handle tube and a dispenser tube and the plunger is translatable within the handle tube to extend the at least one blade into the dispenser tube when the plunger is in the extended position and retract the blade into the handle tube when the plunger is in the retracted position.

16. The system of claim 15, wherein the cylinder further comprises a flange defining an opening in the at least partially open end, the puncturing device configured to align the self-sealing orifice in the flexible container relative to the opening in the cylinder.

17. The system of claim 16, wherein the dispensing gun further comprises a cradle and a front end configured to engage the cylinder to retain the cylinder within the dispensing gun and the dispenser tube is further configured to engage the front end of the dispensing gun and a portion of the cylinder.

18. The system of claim 17, wherein the puncturing device further comprises a shoulder between the handle tube and the dispenser tube and at least a portion of the shoulder is configured to engage the front end of the dispensing gun.

19. A puncturing device for cutting self-sealing orifices in flexible containers containing viscous food, the puncturing device comprising:
a housing comprising a handle tube and a dispenser tube, and a shoulder extending between the handle tube and the dispenser tube;
at least one blade configured to cut a self-sealing orifice in a flexible container containing viscous food;
a plunger secured to the at least one blade and translatable within the housing between a retracted position wherein the at least one blade is retracted into the handle tube and an extended position wherein the at least one blade extends into the dispenser tube; and
a spring extending between the handle tube and the plunger, the spring configured to place a biasing force against the plunger to bias the plunger in the retracted position.

20. The puncturing device of claim 19, further comprising:
a plurality of housing fingers extending inwardly from an interior of the handle tube; and
a plurality of alignment projections extending from the plunger;
wherein at least one alignment projection engages each of the housing fingers to promote even translation of the plunger between the retracted and the extended position.
